(19) United States
(12) Patent Application Publication
(10) Pub. No.: US 2006/0228018 A1
(43) Pub. Date: Oct. 12, 2006

(54) Reconfigurable machine vision system

(76) Inventors: Gil Abramovich, Ann Arbor, MI (US); John Patrick Spicer, Plymouth, MI (US); Jacob Barhak, Ann Arbor, MI (US); Yoram Koren, Ann Arbor, MI (US)

Correspondence Address: HARNESS, DICKEY & PIERCE, P.L.C., P.O. BOX 828, BLOOMFIELD HILLS, MI, 48303, US

(21) Appl. No.: 11/103,927

(22) Filed: Apr. 12, 2005

(51) Int. Cl. G06K 9/00

(52) U.S. Cl. 382/141

(57) ABSTRACT

A machine vision inspection system. The system includes a plurality of cells adjustably interconnected, and a plurality of vision elements. Each vision element can be adjustably supported within one of the cells. The cells and the vision elements can be selectively configured to define a vision arrangement capable of high-resolution inspection of a part.

### FEDERALLY SPONSORED RESEARCH

Certain of the research leading to the present invention was sponsored by the United States Government under National Science Foundation Grant No. EEC-959125. The United States Government has certain rights in the invention.

### INTRODUCTION

Machine vision is commonly used in industry for the inspection of parts in manufacturing processes. Known high-performance machine vision systems generally employ high-cost/high-performance hardware and software for image acquisition and image processing. Significant engineering expertise may be required to integrate the hardware and software to a working system. Such systems can be highly-customized and cannot be easily adapted to changing manufacturing needs.

Although the existing industrial-scale machine vision systems can be satisfactory for their intended purposes, there is still a need for systems that combine accuracy and adaptability at low cost.

### SUMMARY

The present teachings provide a machine vision inspection system that includes a plurality of cells adjustably interconnected, and a plurality of vision elements. Each vision element can be adjustably supported within one of the cells. The cells and the vision elements can be selectively configured to define a vision arrangement capable of high-resolution inspection of a part.

The present teachings also provide a method for reconfiguring the vision arrangement of the machine vision inspection system. In one aspect, the method includes selectively disassembling adjacent rows of cells from each other, selectively shifting adjacent rows relative to each other, and selectively assembling adjacent rows to each other. In another aspect, the method includes selectively disassembling adjacent cells from each other, selectively disassembling adjacent rows of cells from each other, selectively shifting a distance adjustability unit of each cell such that the corresponding vision elements are at a constant clearance distance from a curved surface of the part, selectively re-assembling adjacent cells to each other, and selectively re-assembling adjacent rows to each other.

The present teachings also provide a machine vision inspection system that includes a fixture, a plurality of cells adjustably interconnected and adjustably supported on the fixture, a plurality of vision elements, each vision element adjustably supported within one of the cells, and a control module operable for selectively activating/deactivating each vision element, for image processing, and for inspection measurement. The cells and the vision elements can be selectively configured to define a vision arrangement capable of a high-resolution inspection of a part.

Further areas of applicability of the present invention will become apparent from the detailed description provided hereinafter. It should be understood that the detailed description and specific examples are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a machine vision system according to the present teachings;

FIG. 2 is a diagram illustrating different vision elements for a vision arrangement according to the present teachings;

FIG. 3 is a perspective view of a vision arrangement according to the present teachings;

FIG. 4A is a perspective view of a vision arrangement according to the present teachings;

FIG. 4B is a front (part-facing) view of the vision arrangement of FIG. 4A;

FIG. 5A is a perspective view of a vision arrangement according to the present teachings;

FIG. 5B is a front (part-facing) view of a vision arrangement according to the present teachings;

FIG. 6 is a perspective view of a vision arrangement according to the present teachings;

FIG. 7 is a perspective view of a vision arrangement according to the present teachings;

FIG. 8 is a perspective view of a machine vision inspection system according to the present teachings;

FIG. 9 is a side view of a vision arrangement illustrating field-of-view overlap according to the present teachings;

FIG. 10 is a side view of a vision arrangement illustrating field-of-view overlap according to the present teachings;

FIG. 11 is a side view of a vision arrangement according to the present teachings;

FIG. 12A is a perspective view of a vision arrangement according to the present teachings;

FIG. 12B is a side view of a vision arrangement according to the present teachings;

FIG. 13 is a side view of a vision arrangement according to the present teachings;

FIG. 14A is a perspective view of a machine vision inspection system according to the present teachings;

FIG. 14B is a side view of the machine vision inspection system of FIG. 14A;

FIG. 15 is a perspective partially exploded view of a cell with a light source vision element according to the present teachings;

FIG. 16 is a perspective view of a vision arrangement according to the present teachings;

FIG. 17 is a perspective view of a vision arrangement according to the present teachings;

FIG. 18A is a perspective view of a machine vision inspection system according to the present teachings;

FIG. 18B is a side view of the machine vision inspection system of FIG. 18A;

FIG. 19 is a perspective view of a vision arrangement according to the present teachings;

FIG. 20A is a perspective view of a cell arrangement according to the present teachings;

FIG. 20B is a plan view of a vision arrangement according to the present teachings;

FIG. 21 is a perspective view of a vision arrangement according to the present teachings;

FIG. 22 is a perspective view of a vision arrangement according to the present teachings;

FIG. 23 is an exemplary diagram of a software architecture of a control module according to the present teachings;

FIG. 24A is a diagram of an exemplary color-coded calibration grid according to the present teachings, with colors replaced by letters; and

FIG. 24B is an exemplary calibration word for a calibration grid according to the present teachings.

### DETAILED DESCRIPTION

The following description is merely exemplary in nature and is in no way intended to limit the invention, its application, or uses. For example, the present teachings can be used for machine vision inspection of machined parts, such as engine blocks, cylinder heads, for example, in manufacturing applications to detect surface defects and porosity or for dimension measurements. The present teachings, however, are not limited to such applications and can be used for any type of machine vision applications.

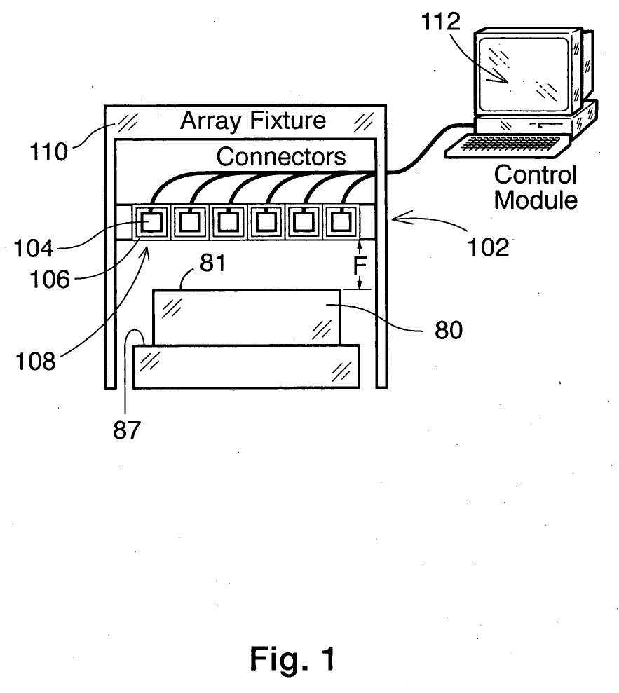

Referring to FIG. 1, an exemplary machine vision inspection system 100 according to the present teachings may include a modular vision arrangement 102 that includes a plurality of vision elements 104. Each vision element 104 can be movably housed in a cell 106, although each cell can include none, or one, or more than one vision elements 104. The cells 106 can have any shape, such as, for example, cubic, parallelepiped, cylindrical, spherical, portions thereof, or other shapes. The cells 106 can have solid walls or can be wire structures, and can be individual units or integrated into multiple units or into a frame or portions thereof.

The inspection system 100 can include one or more computers, processors, programmable logic controllers, or other control units collectively referred as a control module 112. The control module 112 can be operably connected or communicating with each vision element 104 to selectively activate, de-activate, move, or otherwise control the vision element 104 using main lines, wireless communication, internet and broadband communication, or other known devices. By controlling the activation/de-activation of individual vision elements, the configuration of the active vision arrangement 102 can be changed. For example, entire rows 109 or columns of vision elements 104 can be selectively activated/de-activated, or individual vision elements 104 can be selectively activated/de-activated to produce a particular geometric pattern, such as a polygon, ring, or other pattern. Random activation/de-activation can also be selected. Activation/deactivation of individual vision elements 104 can also be manual. The vision elements 104 can be powered individually by batteries, main lines or power outlets. The vision elements 104 can also share power and a communication line such as a Universal Serial Bus (USB). The vision elements 104 can be individually and selectively triggered to capture images at various combinations of time instances. For example, in applications requiring high resolution or in three-dimensional applications with moving parts 80, all the sensor-type vision elements 104 can be triggered to capture images at the same time instance, by using software control or dedicated electrical pulse (TTL signal). In another example, a fast moving part 80 can be followed through the fields-of-view of different vision elements 104. In such applications, serial image capture at a sequence of appropriate time intervals is required.

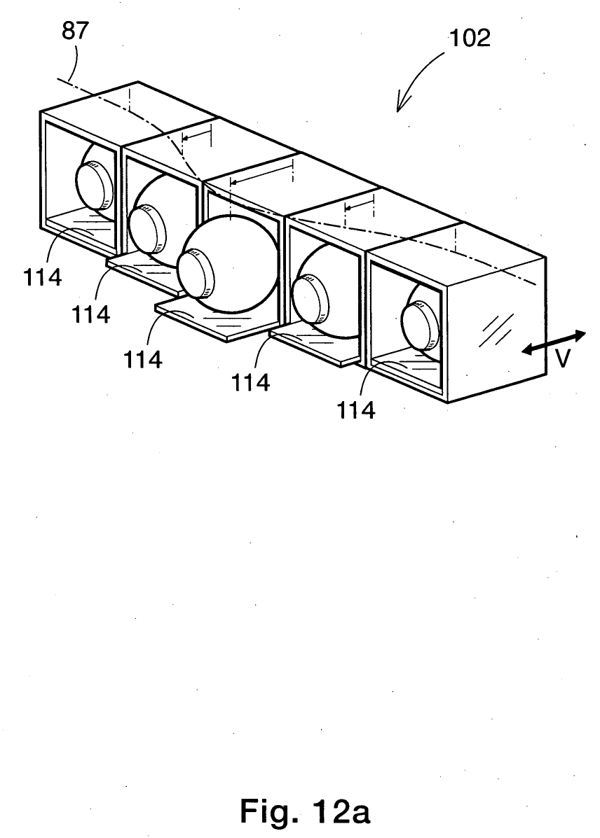

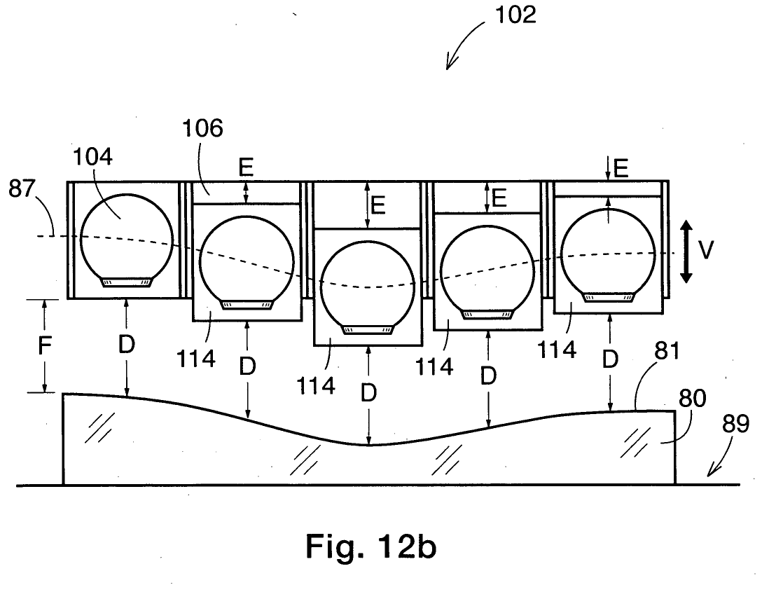

Each vision element 104 can be selectively adjustable within the corresponding cell 106. The available adjustments for each vision element 104 can include, although not limited to, removing, re-installing the vision element, and moving the vision element to change pan, tilt, roll, or other translation or rotation of the element. The vision elements 104 can also be supported on distance adjustability units 114 that provide clearance or standoff distance adjustability for individual cells 106, such as, for example, slidable trays, drawers, or other motion units, as discussed in further detail below and best illustrated in FIGS. 12A and 12B. The distance adjustability units 114, for example, enable the selective positioning of individual vision elements 104 at desired or specified standoff or clearance distances “D” from a curved surface 81 of the part 80.

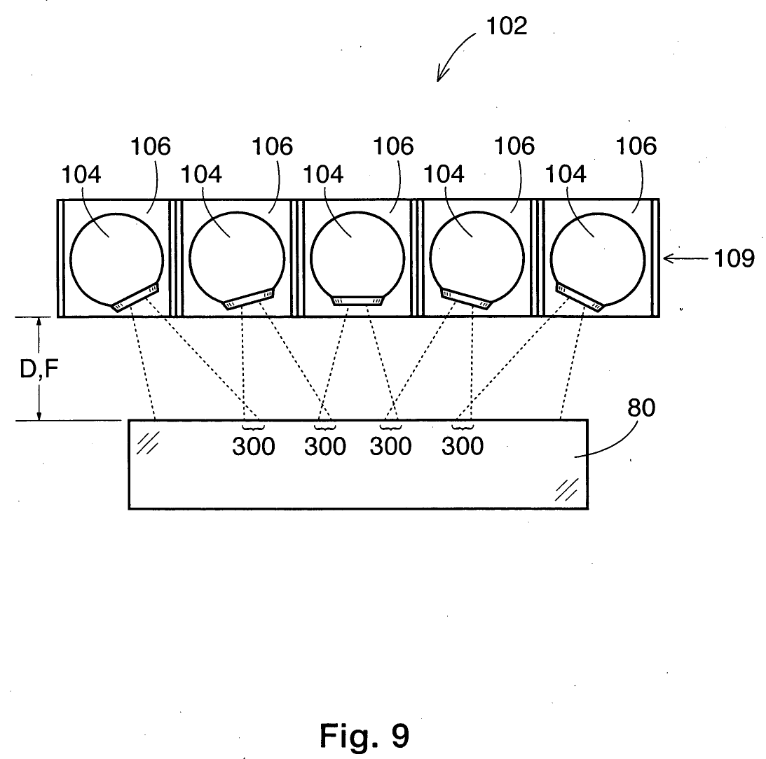

The vision arrangement 102 can include a linear (one-dimensional), or a two- or three-dimensional configuration of vision elements 104, as discussed below. The vision elements 104 are housed in the cells 106, which define a vision structure 108 associated with the vision arrangement 102. The vision structure 108 of the vision arrangement 102 can be selectively adjustable, such as movable and reconfigurable from one configuration to another configuration, as described below. Each cell 106 of the vision structure 108 can also be selectively adjustable, such as movable, removable, and reconfigurable separately or together with other cells 106. The vision structure 108 can also be adjustably (such as movably, removably, and reconfigurably) supported on a frame or other fixture 110. The fixture 110 can support the vision structure 108 at a desired clearance or standoff distance “F” from the part 80 to be inspected for surface inspection or dimensional measurement. The distance F can be variable and selectable from a pre-determined range of distances that can be accommodated by known mechanical coupling means between the fixture 110 and the vision structure 108. The coupling means can include various known slidable and pivotable connections. It will be appreciated that the clearance distance F of the vision structure 108 and the clearance distances D of the individual vision elements can be all equal, as illustrated, for example, in FIGS. 1 and 9, or unequal, as illustrated, for example, in FIG. 12B.

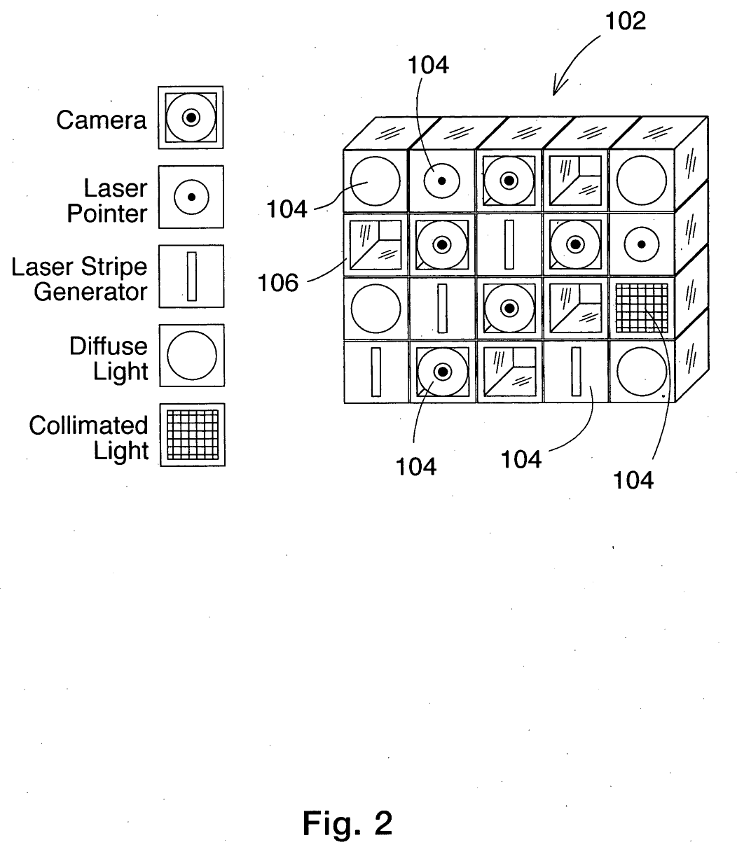

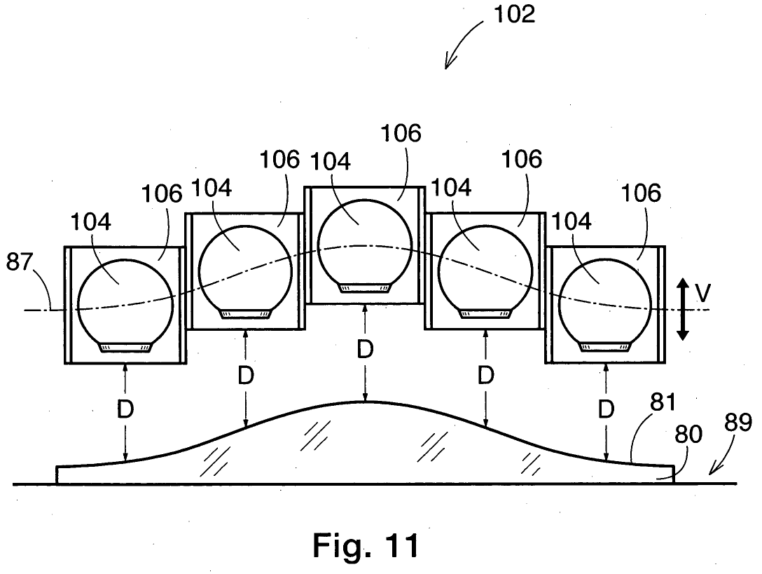

Referring to FIG. 2, an exemplary vision arrangement 102 is illustrated to include different vision elements 104 arranged in a two-dimensional array configuration that includes rows 109, or columns 111. The vision elements 104 can include various sensors, such as cameras, laser-based sensors, including laser pointers, and laser stripe scanners or laser line generators, various illuminators, such as diffuse light and collimated light illuminators, light projectors and emitters, light bulbs, Light Emitting Diodes, strobe lights, fiber optics, and other known vision elements 104 for sensing or illuminating the part 80 in connection with machine vision. The vision elements 104 can be arranged as an array of rows 109 and columns 111, but the vision arrangement 102 need not be limited to configurations of rows 109 and columns 111, and need not be distributed on a planar surface. For example, the vision elements 104 can be distributed on a three-dimensional, non-planar, or curved surface, as illustrated in FIG. 11. The vision elements 104 can include mass-produced, consumer-oriented products, such as web cameras, digital cameras, and other low-cost sensors and illuminators or light sources, although customized industrial vision elements can also be used.

The control module 112 can include integral, or separate but intercommunicating, modules that can process data received from the vision elements 104, and provide inspection information and dimensional measurements for the part 80. The control module 112 can include integrated software or interconnected modules that can perform various functions for the inspection process. For example, the control module 112 can process images captured by the sensor-type vision elements 104, and can control the illumination of the vision elements 104 that are illuminators, projectors or other light sources. The control module 112 can also process calibration software routines for the entire inspection system 100, or for parts thereof, or for individual vision elements 104. Further, the control module 112 can include standard, customized, and customizable machine vision software for processing images and providing desired inspection information.

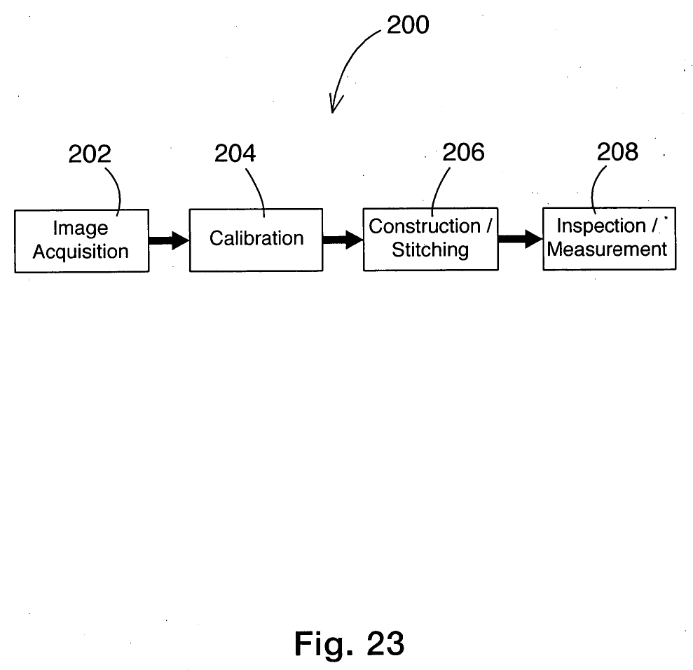

Referring to FIG. 23, an exemplary software architecture 200 for the control module 112 is illustrated. The architecture 200 can include an image acquisition module (or component) 202, a calibration module 204, a stitching or image construction module 206 and a vision inspection/measurement module 208. The image acquisition module 202 can acquire, upon command, an image from each individual camera-type vision element 104 in the vision arrangement 102. The images can be stored in files that can be processed by the image calibration module 204. Commercially available image acquisition software packages can be used. When using mass-produced sensors or web cameras having software that does not include the capability to programmatically control the triggering of multiple cameras, the image acquisition module 202 can be constructed as described below by a person of ordinary skill in the art.

In an exemplary aspect, the image acquisition module 202 can be constructed to include two main software modules or components. The first component can be a high-level command tool (written in C++ language, for example, or other appropriate language) that controls the overall image acquisition and storage process. This high level command tool can interface directly with the second software component, which can be a runtime object software tool, or other appropriate software tool. During operation, triggering commands can be sent from the high-level command tool to the runtime object software when it is necessary to acquire and store images. The runtime object software can then handle low-level communication and control of the individual web-cameras. The runtime object software can also individually and selectively control camera parameters such as contrast and brightness. Images can be stored, for example, as files with resolution of 640×480 pixels format. It will be appreciated that other known data acquisition modules that provide desired control of the cameras or other sensors of the vision arrangement 102 can be used.

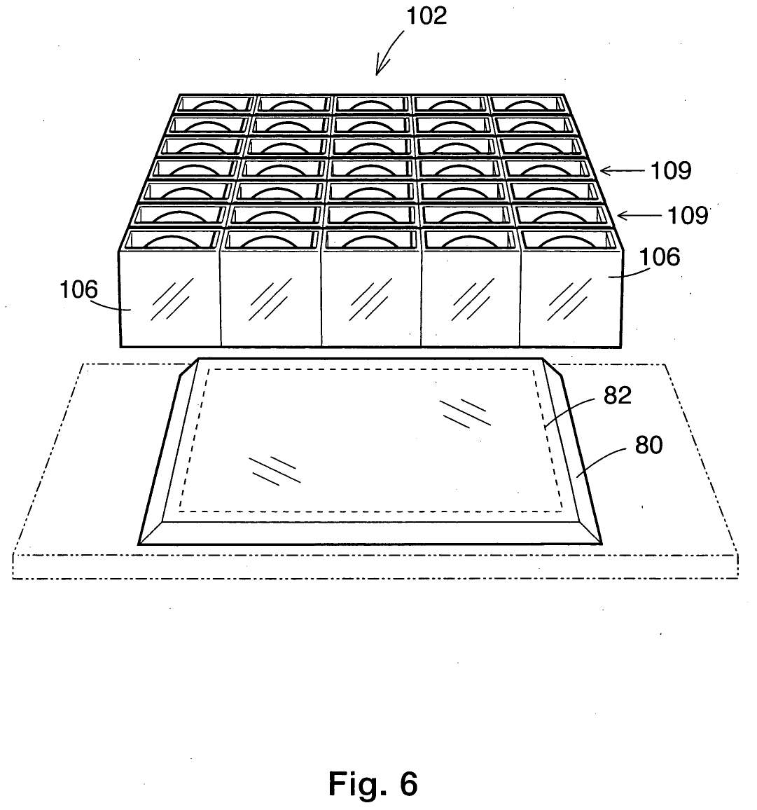

The calibration module 204 can be used to calibrate the camera-type vision elements 104 individually and mutually using images of a master calibration rig 82 (shown schematically in FIG. 6), which has been placed in the same plane as the surface 81 of the part 80. Images of the calibration rig 82 can be acquired from every camera, with all cameras in focus. The images of adjacent camera-type vision elements 104 can be made to overlap slightly (e.g. 10%) to ensure that a complete image of the calibration rig 82 can be obtained. Overlap can be used to obtain full, continuous images, for applications such as surface defect inspection of manufactured or machined components and other parts 80. As described below, calibration allows registration of images to proper relative positions without requiring overlap.

After image acquisition, each image of the calibration rig 82 can be individually used to calibrate the internal parameters of each camera. During the process, the images are rectified to remove lens distortion. Each rectified calibration image can be compared against the master calibration grid 82. At least four points on each image and corresponding points on the master calibration pattern can be selected. Using these corresponding point pairs, image transformation matrices (homographies) can be calculated using known methods. These transformations align the camera images to the master pattern.

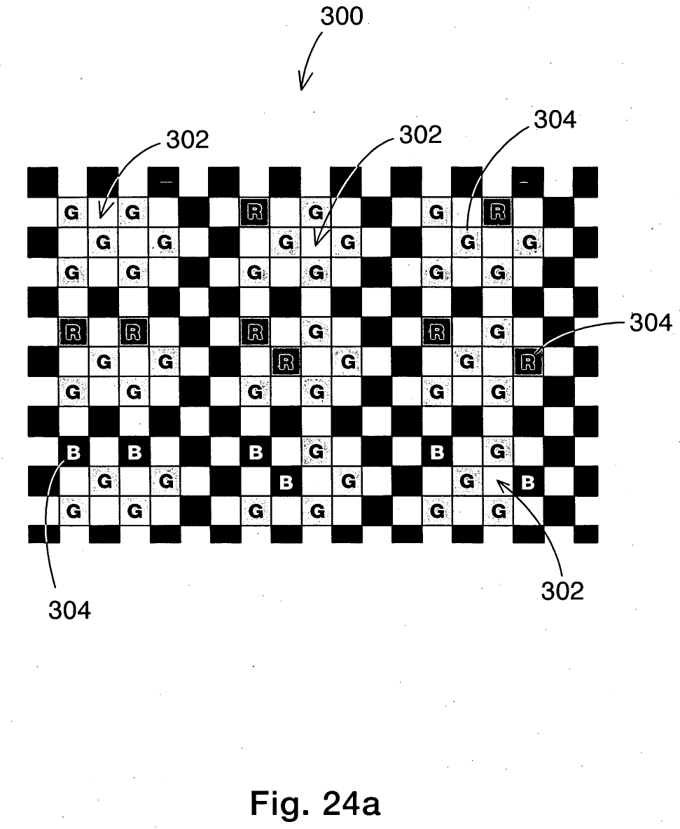

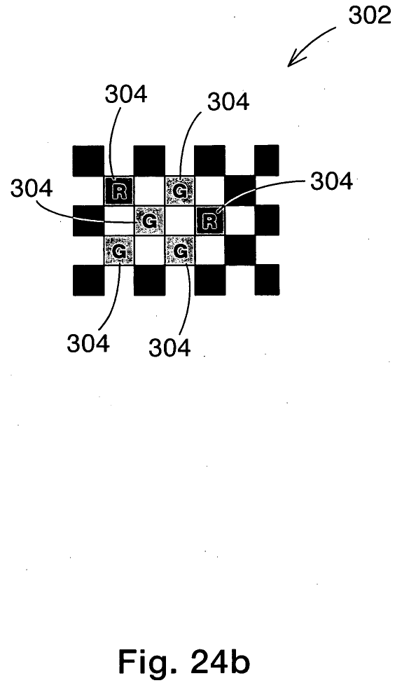

Referring to FIGS. 24A and 24B, an exemplary machine-readable color-coded calibration grid 300 for the calibration rig 82 is illustrated. The grid 300 defines “calibration words” 302 constructed from “calibration letters” 304. Each calibration word 302 can be constructed from a pattern of colors, and each color can represent a calibration letter 304. A sequence of color calibration words 302 can be written on the grid 300. Each calibration word 302 can be placed in a known position and orientation. By reading the calibration words 302 that are in view of camera-type vision elements 104, the control module 112 can determine the exact position and orientation of each point in the image with respect to the calibration grid 300. Calibration words 302 can be constructed such that by reading a single calibration word 302, the vision system 100 can determine position and orientation uniquely.

In the black and white drawings of FIGS. 24A and 24B, the different colors of the calibration letters 304 are diagrammatically represented by the initial of the color name, such that “R” stands for red color, “B” for blue color, and “G” for green color. Calibration words 302 can be separated by rows and columns of black (no-color) blocks, and calibration letters 302 can be separated by white blocks. Calibration words 302 can have enough complexity to ensure that each calibration word 302 is used only once on the calibration grid 300. Calibration words 302 are not to be repeated in the same calibration grid 300.

Referring to FIG. 24B, an exemplary calibration word 302 is illustrated. In this example, the calibration word 302 includes six calibration letters 304. Written linearly, this calibration word 302 can be represented by the sequence RGGRGG, where R stands for red and G stands for green. The number of available calibration words 302 can be increased by increasing the number of different calibration letters 304 available in a “calibration alphabet” by providing additional distinct colors, and by increasing the size of the calibration words 302 by using a greater number of calibration letters 304 in each calibration word 302. For example, given (n) calibration letters 304 in a calibration alphabet, and calibration words 302 of fixed size (m), there are n^{m} available different calibration words 302. Complexity can be increased further by including the option of using calibration words 302 of varying sizes (different number of calibration letters 304 in the calibration words 302). Each calibration word 302 can be asymmetrical so that its orientation can be determined without ambiguity. In FIG. 24B, the orientation of the calibration word 302 on the grid 300 can be uniquely defined by the presence of the color red calibration letter 304 on the right side of the calibration word 302.

Referring to FIG. 24A, an image of an exemplary calibration grid 300 is illustrated. The exemplary calibration grid 300 uses calibration words 302 comprising six letters 304. There are three available calibration letters 304 in this exemplary calibration alphabet, green (G), red (R), and blue (B). There are, therefore, 3⁶=729 possible different calibration words 302 that can be constructed for this exemplary calibration grid 300. The asymmetry in the word structure uniquely defines the orientation of each calibration word 302. The presence of black blocks or “gaps” between the calibration words 302 enables the vision system 100 to differentiate between calibration words 302.

In the image construction or stitching module 206, the extracted calibration parameters and transformation matrices (homographies) can be used to automatically assemble image files acquired from the part 80 into a single image. The result is a single, continuous, undistorted image of the part's surface 81.

The fully constructed/stitched image of the part 80 developed in the stitching module 206 can be analyzed in the measurement module 208 with standard machine vision inspection software, such as, for example, freely available machine vision source codes. Exemplary inspections of the part 80 include measurement of dimensions, such as hole diameters and distances between features. Other inspections can also include the presence or absence of certain features, and surface flaw detection.

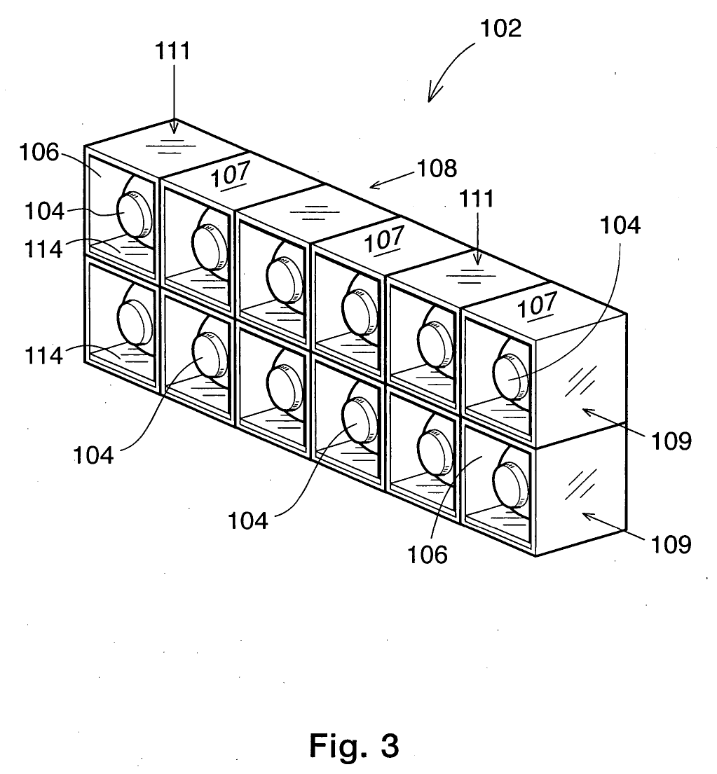

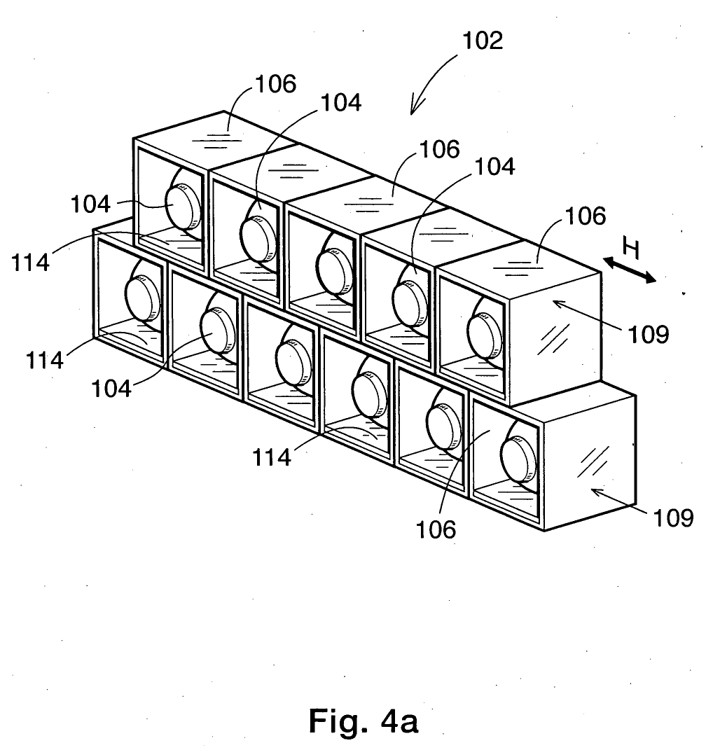

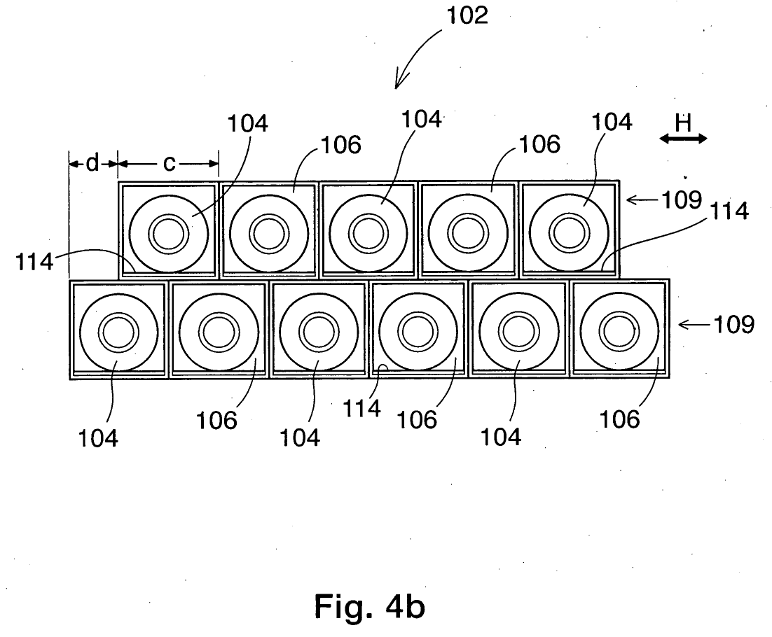

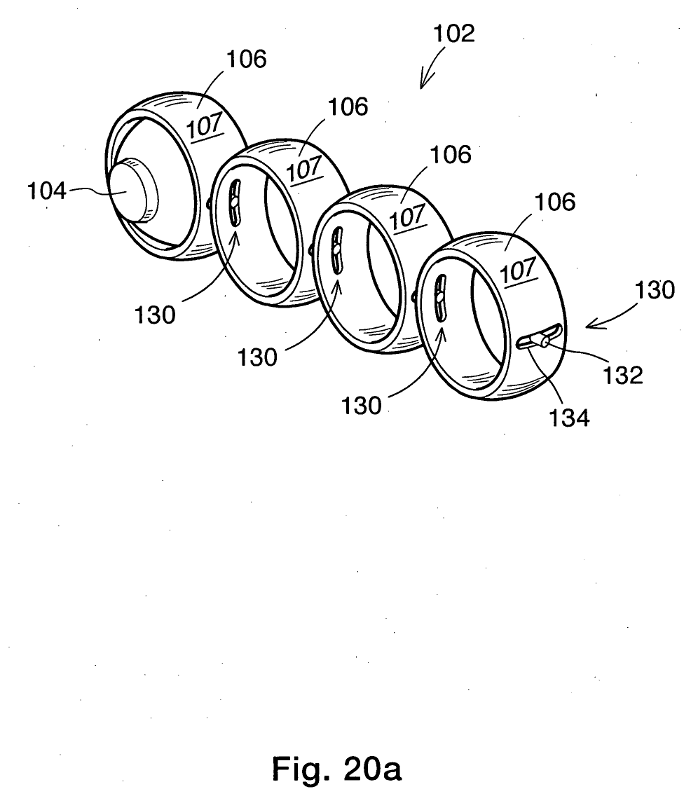

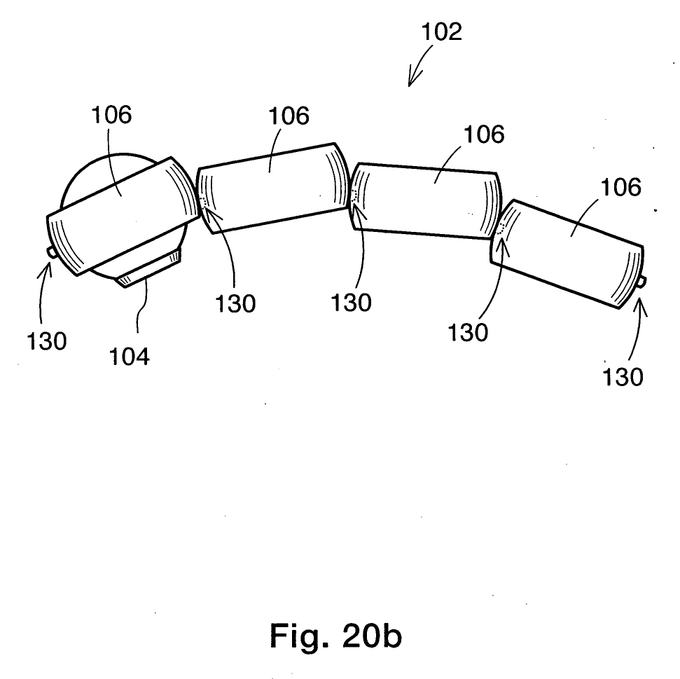

Various exemplary configurations of the inspection system 100 are illustrated in FIGS. 3-22. Referring to FIG. 3, the vision arrangement 102 can be a modular arrangement of vision elements 104 in cells 106 that define a Cartesian or rectangular-grid structure for the vision arrangement 102 with a variable number of rows 109 or columns 111, as well as variable number of cells 106 in each row 109 or column 111. The modular design allows individual cells 106 to be selectively added or removed from the vision structure 108, thereby reconfiguring the vision arrangement 102 to a new configuration with different number of rows 109, columns 111, or vision elements 104. Each cell 106 can be adjustably connected to adjacent cells 106 by known adjustable fastening devices 130, as shown, for example, in FIGS. 20A and 20B. The rows 109 of FIG. 3 are arranged “in-line”, in contrast to the staggered arrangement of FIG. 4, described below.

The adjustable fastening devices 130 can be fastening devices or mechanisms that allow flexible assembly/disassembly and reconfiguration of the vision structure 108 of vision arrangement 102, as described below. The adjustable fastening devices 130 can include movable, removable, slidable, pivotable, rotatable and generally adjustable screws or bolts 132 that can be received in holes, slots or other fastening guides 134 on the cell surfaces 107. The adjustable fastening devices 130 can also include magnets, hoop and loop fasteners, snap-fit attachments, slidable, pivotable, rotatable and generally adjustable connectors and couplers, or other fastening mechanisms that allow reconfiguration and/or removal of individual cells 106, entire rows 109 or columns 111 of cells 106.

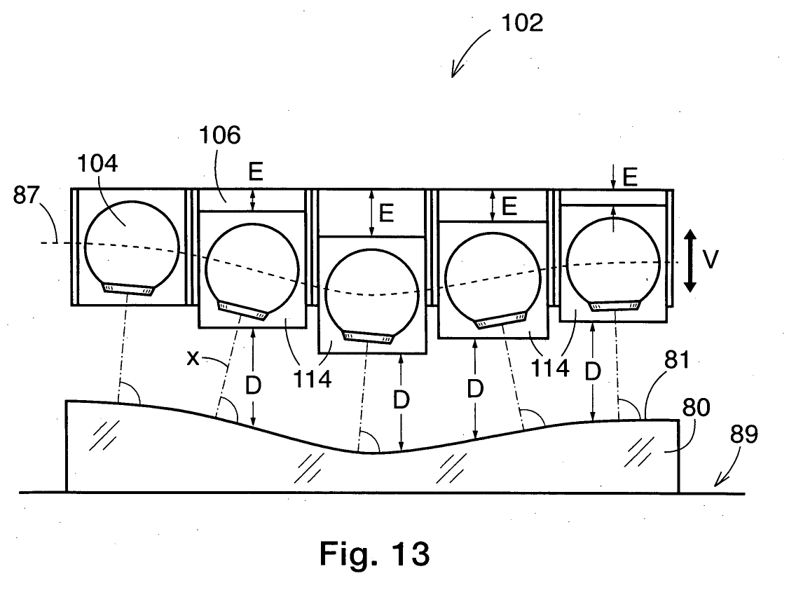

Each cell 106 can include its own distance adjustability unit 114 that allows individual standoff or altitude adjustment from the inspected surface 81 of the part 80. Additionally, the distance adjustability units 114 can be moved for individualized positioning and adjustment of each vision element 104 on the distance adjustability unit 114 of the cell 106, as illustrated in FIG. 13, for example. Adjustments of the vision elements 104 can include pan, tilt, roll, altitude and field-of-view adjustments, and also completely removing or adding vision elements 104. Using the adjustments available for the cells 106 and the vision elements 104, the vision arrangement 102 can be configured such that a complete image of the part 80 can be obtained by automatically stitching images captured by individual vision elements 104. Neighboring cells 106 can be configured to provide only a slight overlap 300 for stitching, as illustrated, for example, in FIG. 9. The image thus constructed can be a high resolution image, capable for defect detection and dimensional measurement of machined parts 80, and can be created by using a plurality of low-resolution vision elements 104, which can be obtained at low cost as mass-produced, consumer-style cameras or illuminators

Referring to FIGS. 4A and 4B, an exemplary staggered configuration of the vision arrangement 102 is illustrated. In this exemplary configuration, one row 109 of cells 106 is shifted relative to an adjacent row 109 by a shift distance “d” which is half the length “c” of a cell along the direction of the row 109, as indicated by arrows “H”. Using the adjustable fastening devices 130 described above, the staggered configuration of FIGS. 4A and 4B can be converted to the configuration of FIG. 3, and conversely, by a quick manual process, such as, for example, selectively disassembling rows 109 and/or cells 106 as necessary, selectively shifting, and selectively re-assembling. Using selective staggering, the resolution of the global image can be increased to a desired degree, for example by adding more rows 109 to the vision arrangement 102. Resolution enhancement can be achieved, for example, by acquiring an image of a strip of the part 80 and then shifting the vision arrangement 102 relative to the part 80 by a displacement in a direction perpendicular to the longitudinal axis of the strip by one-half the cell length, c/2, and capturing individual images again. Each strip has non-overlapping fields-of-views. A combination of images captured using two rows 109 of vision elements 104 enables filling the gaps between frames produced by a single row 109 of vision elements 104 and creates a high-resolution image which is stitched from individual overlapping images. More rows 109 can be similarly added to provide additional resolution increases.

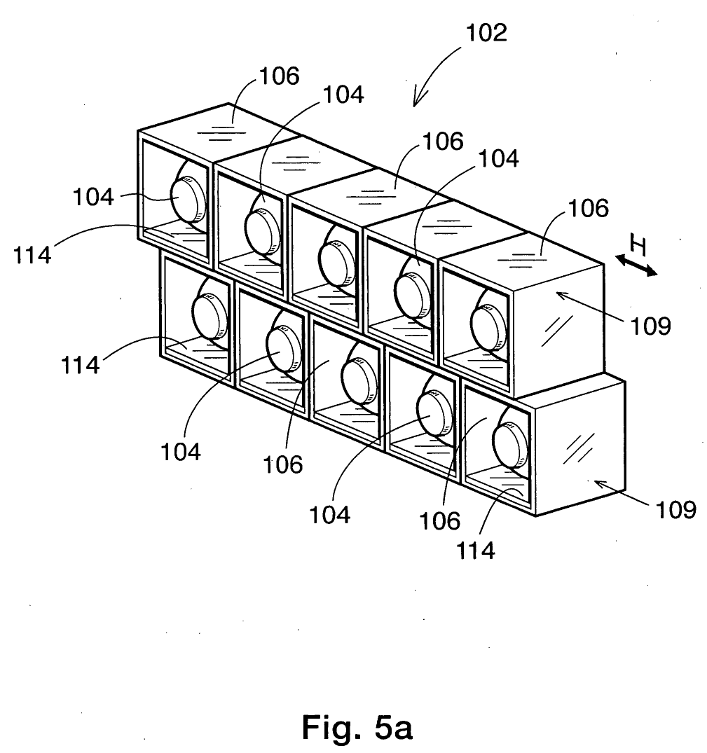

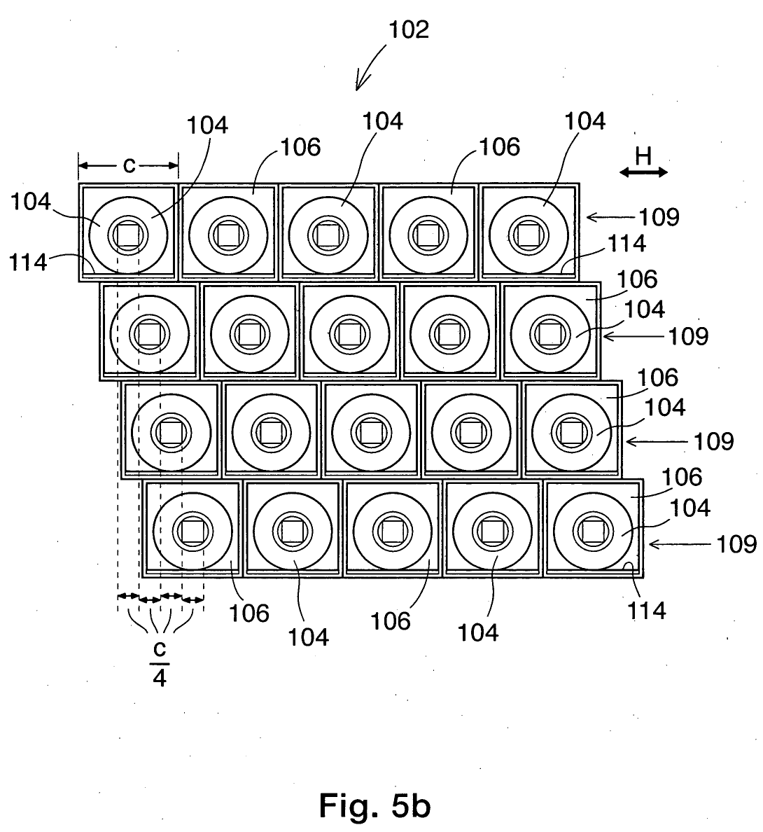

Referring to FIGS. 5A and 5B, an exemplary staggered configuration of the vision arrangement 102 is illustrated with a shift of one-quarter the length c of a cell 106. The quarter shift allows a resolution increase in the row direction H four times the one achieved by a single row 109 of vision elements 104. This resolution increase can be achieved as follows. One row 109 of vision elements 104 captures a certain strip of the part 80 where the field-of-view of each vision element 104 is only slightly more than ¼ of the cell dimension c in the row direction H. Then, sequentially, adjacent rows 109 capture the same strip of the part 80, and because of the row-direction shift, the gaps in the images are filled. Thus, a high resolution image is constructed, with four times the resolution that can be achieved by a single row 109 of vision elements 104. It will be appreciated, however, that staggering can include shifts in the row direction H having lengths that are equal to other fractions of the cell length c, as desired in a particular application.

Referring to FIG. 6, an exemplary configuration, similar to the configuration described in connection with FIG. 3, is illustrated. In the configuration of FIG. 6, the vision arrangement 102 is configured for inspecting the entire part 80 at once, such that all the vision elements 104 produce images of the part 80 simultaneously. The part image is stitched from the images of all the vision elements 104 in the vision arrangement 102. In this configuration, there is no relative motion between the inspected part 80 and the vision arrangement 102.

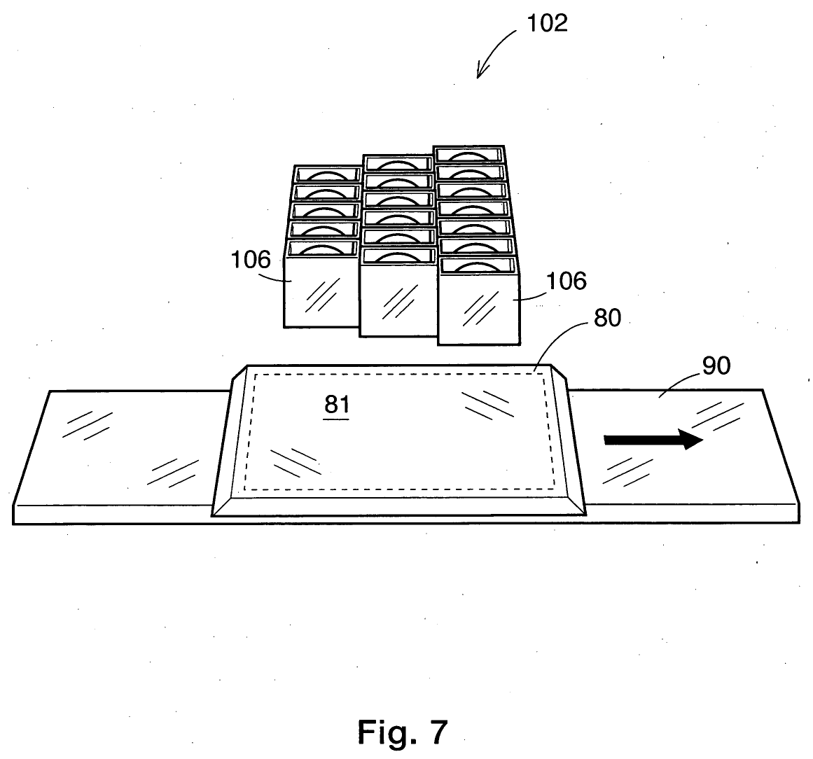

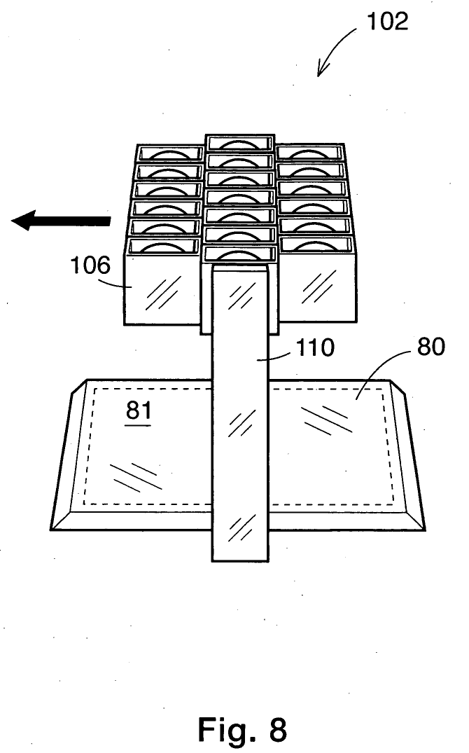

Referring to FIG. 7, an exemplary staggered configuration of the vision arrangement 102, similar to the configuration described in connection with FIG. 4, is illustrated. Each region of the part 80 can be inspected two or more times by the vision arrangement 102 to increase the image resolution. In this exemplary configuration, the vision arrangement 102 is stationary, while the part 80 is moving on a conveyer 90. Referring to FIG. 8, the staggered vision arrangement 102 moves relative to the part 80 that remains stationary. The vision arrangement 102 can be mounted for motion on known motion systems, such as linear stages, rotary stages, and robotic arms, for example.

Referring to FIG. 9, exemplary selective tilting of each vision element 104 of the vision arrangement 102 is illustrated. In this exemplary illustration, increased resolution of a small field-of-view of the part 80 can be achieved by selectively tilting the vision elements 104 to create slightly overlapping fields-of-view having overlaps 300, thereby producing a combined image of high resolution.

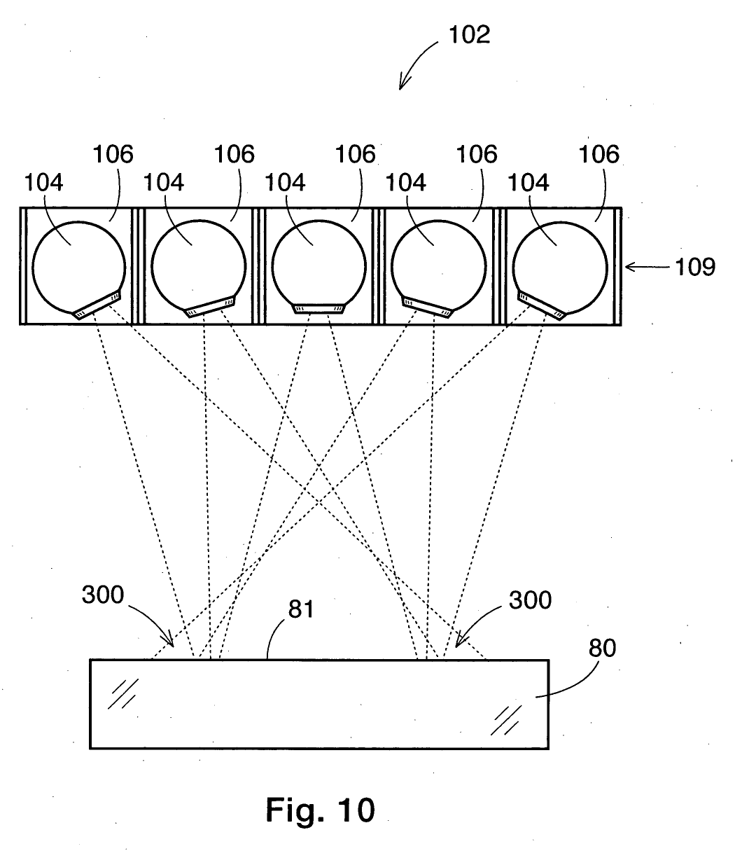

Referring to FIG. 10, a different use of tilting the vision elements 104 in the vision arrangement 102 is illustrated for three-dimensional image acquisition. In this exemplary configuration, more than one vision elements 104 are viewing the same field-of-view with significant mutual overlaps 300. Thereby, depth information can be acquired by stereoscopic reconstruction. The configuration of FIG. 10 can also be used for improved detection accuracy of certain features of the part 80, such as, for example, edges, holes or other geometric features. For example, edge detection errors associated with the angle of the vision element 104 relative to the surface 81 of the part 80 can be at least partially cancelled by integrating images from symmetrically positioned vision elements 104. Additionally, improved accuracy can be achieved because the fields-of-view of the individual vision elements 104 are not identically overlapping.

Referring to FIG. 11, an exemplary configuration illustrates relative shifts between cells 106 in the direction of arrows “V” orthogonally to a support surface 87 for the part 80. Relative shifting between adjacent cells 106 is enabled by the adjustable fastening devices 130 that interconnect the individual cells 106, as described above. This type of clearance or standoff shifting, which is vertical when the part 80 is positioned on a horizontal surface 87, allows, for example, positioning the individual vision elements 104 selectively at clearance distances “D” from a non-flat or curved surface 81 of the part 80. The clearance distances D can be variable across vision elements 104. The clearance distances D can be also be constant across vision elements 104, such that all clearance distances D are equal, and the vision elements 104 define a curved surface 87 that corresponds to the curved surface 81 of the part.

Referring to FIGS. 12A and 12B, clearance shifting in the direction of arrows V can be enabled by selectively moving the distance adjustability units 114 in different positions relative to the cells 106, as shown by arrows “E”. The vision elements 104 define a curved surface 87 that corresponds to the curved surface 81 of the part.

Referring to FIG. 13, variable and selective positioning of the distance adjustability units 114 and selective tilting of each vision element 104 can be used to position the vision elements 104 at orientations “X” that are orthogonal to the curved surface 81 of the part 80 and at constant/equal clearance distances D from the surface 81 of the part 80.

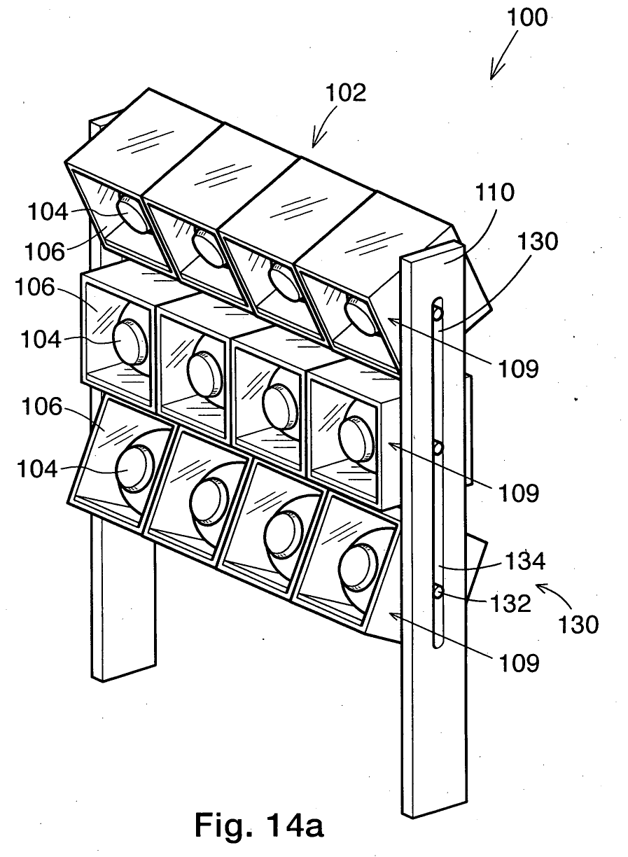

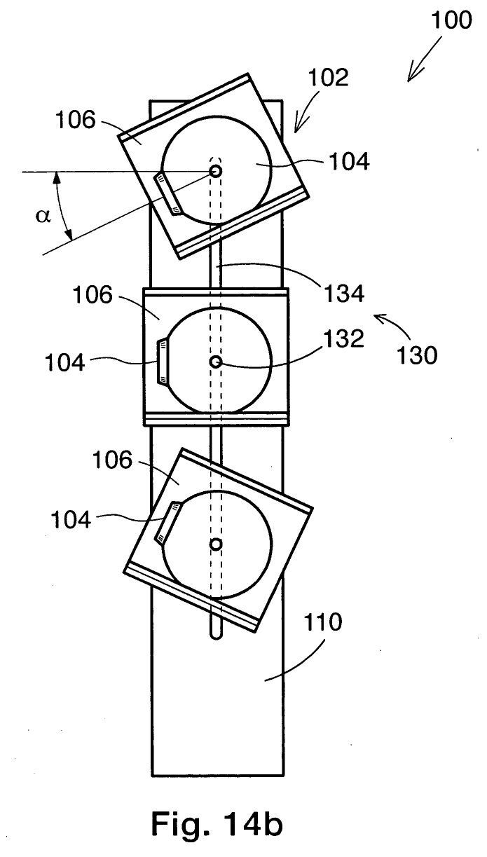

Referring to FIGS. 14A and 14B, an exemplary configuration of the vision arrangement 102 illustrates tilting and pan. In this illustration, each row 109 can be tilted separately, with the vision elements 104 of each row 109 tilted by a common angle a, for example by rotating the structural frame of each row 109 independently from the other rows 109. Additionally, each vision element 104 can be provided with separate pan and roll adjustability in its cell 106 using known supports that typically provide rotation about three (or fewer) orthogonal axes to accommodate pan, tilt and roll, as desired in a particular application. Although the cells 106 are illustrated with cubic shapes, other shapes can also be used, such as parallelepiped, cylindrical, spherical, and portions thereof, as described below.

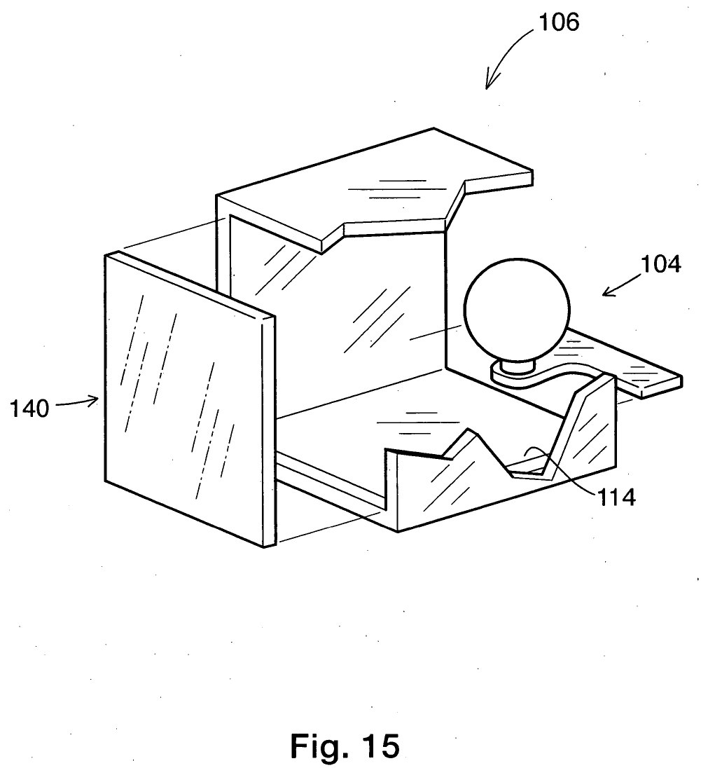

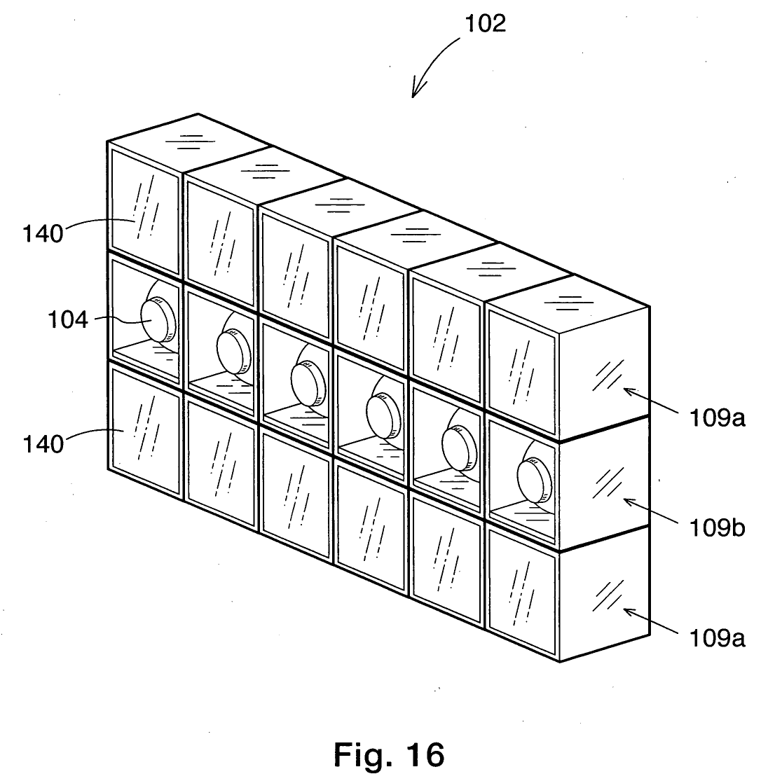

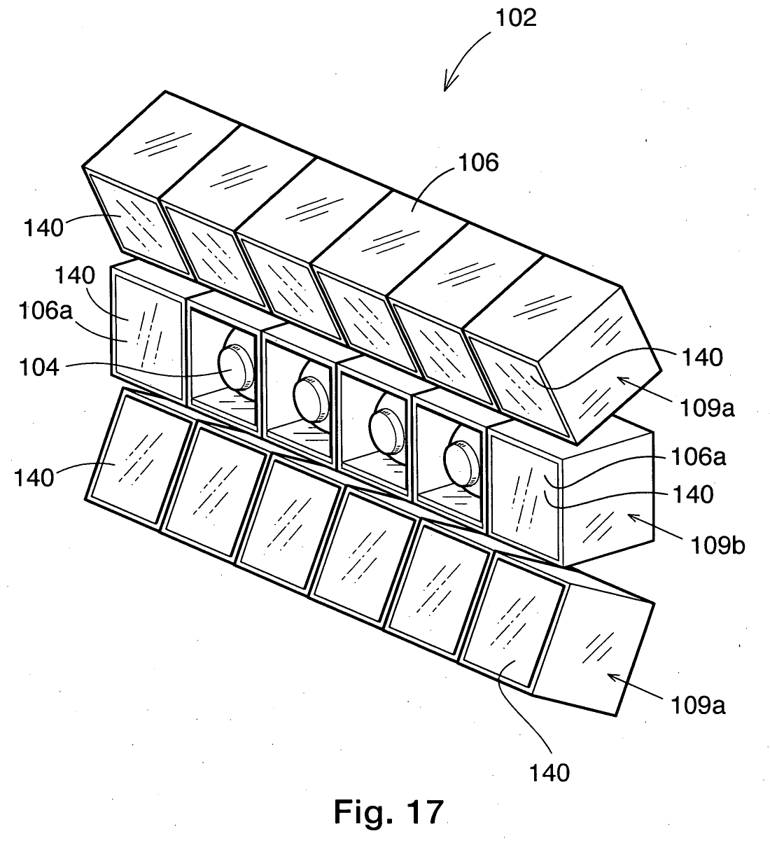

Referring to FIGS. 15-17, exemplary vision arrangements 102 with integrated diffuse illumination are illustrated. An exemplary cell 106 that houses a vision element 104 in the form of an illuminator or light source, such as a bulb, is illustrated in FIG. 15. A diffuser 140 can be selectively positioned on a side of the cell 106 that faces the part 80. FIG. 16 illustrates an exemplary vision arrangement 102 that includes a row 109b of sensor-type vision elements 104 positioned symmetrically between two rows 109a of diffused light vision elements 104, each row 109a defining a diffuse light bar. FIG. 17 illustrates an exemplary vision arrangement 102 similar to that of FIG. 16, but showing the light bar rows 109a rotated relative to the sensor-carrying row 109b. Additionally, light sources with diffusers 140 can be positioned at end cells 106a of the sensor-carrying row 109b.

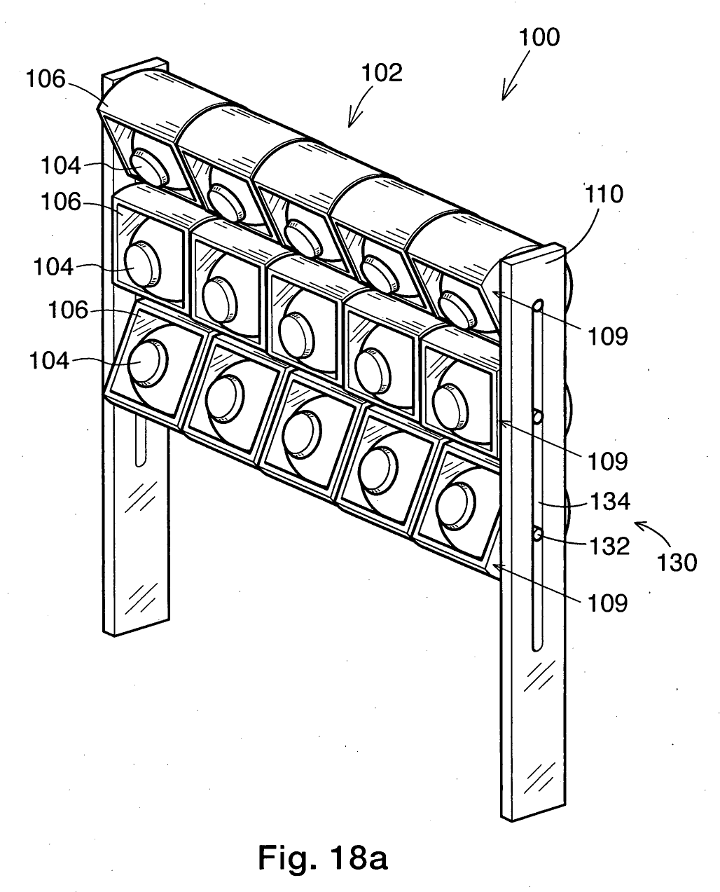

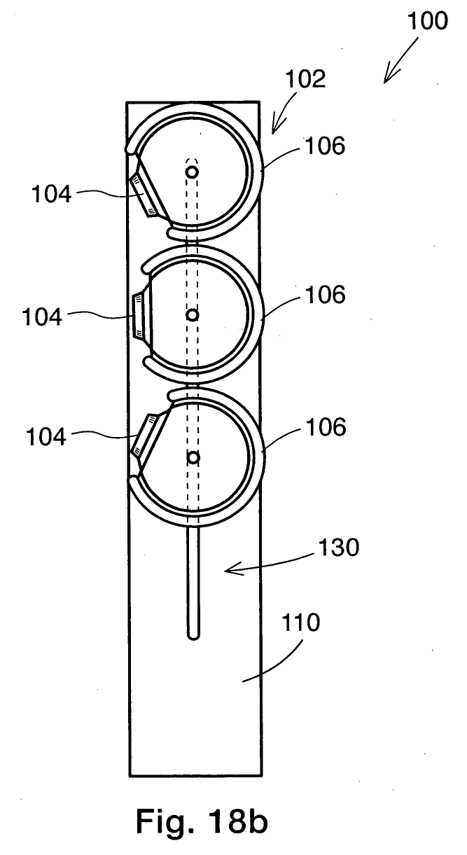

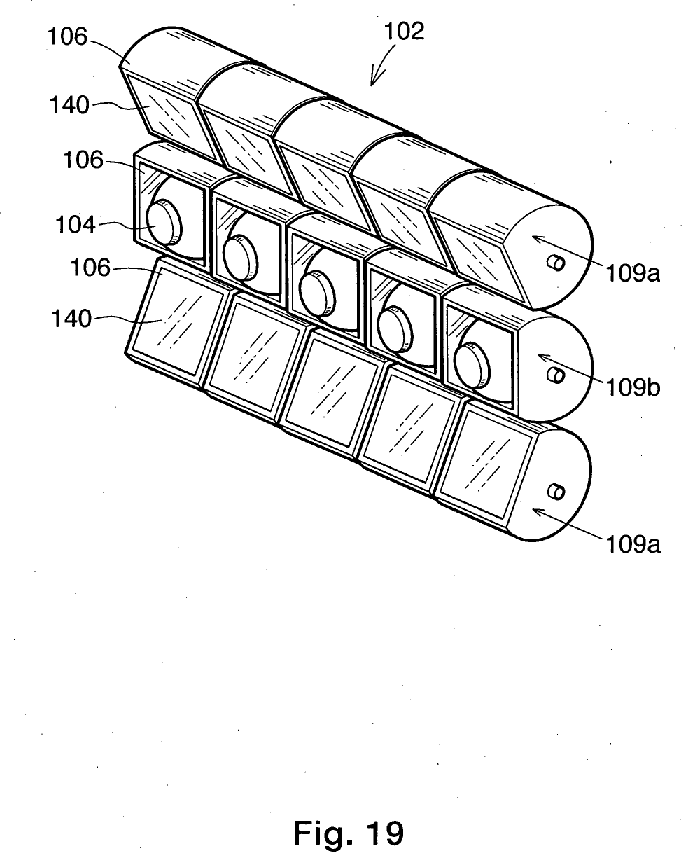

Referring to FIGS. 18A, 18B and 19, exemplary configurations of the vision arrangement 102 incorporating cylindrical cells 106 are illustrated. FIGS. 18A and 18B are similar to FIGS. 14A and 14B. Cells 106 with cylindrical shape can be used, for example, to position rotatable rows 109 closer together. FIG. 19 is similar to FIG. 17 and includes light bar rows 109a rotated relative to the sensor-carrying row 109b.

Referring to FIGS. 20A and 20B, an exemplary vision arrangement 102 that includes cells 106 having spherical portions interconnected with adjustable fastening devices 130 is illustrated. The spherical shape of the cells 106 provides additional flexibility for the overall shape of the vision arrangement 102.

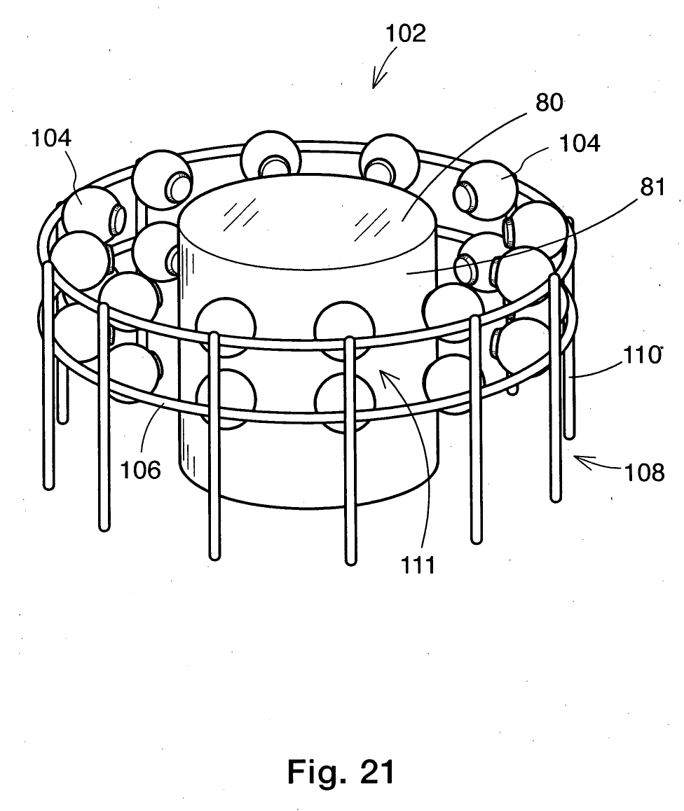

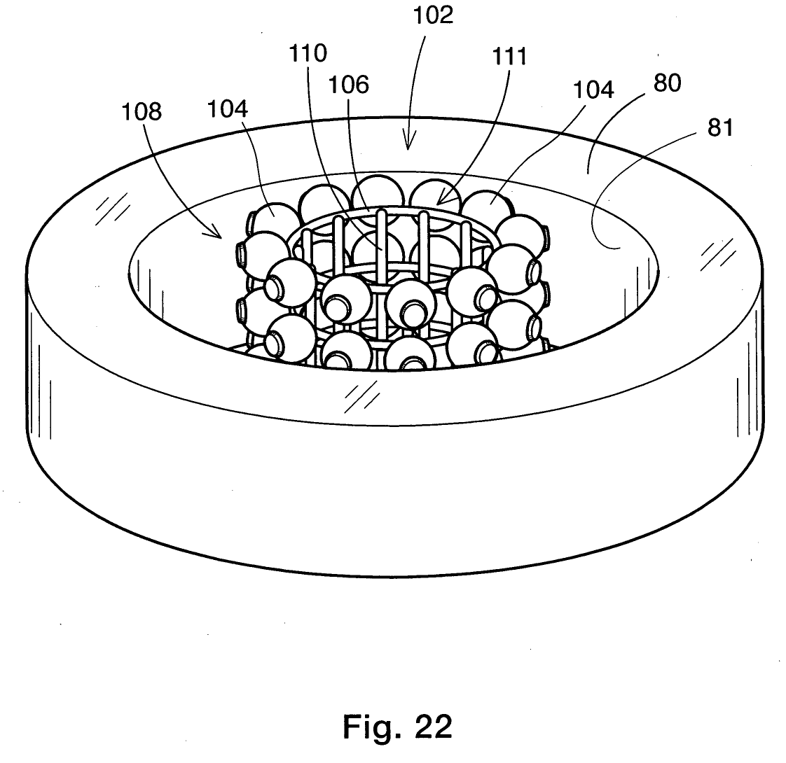

Referring to FIGS. 21 and 22, exemplary vision arrangements 102 for inspecting the outer or inner surfaces 81 of cylindrical parts 80 are illustrated. The vision elements 104 can be supported on a frame 110 that defines wire cells 106 and a cylindrical vision structure 108 outside or inside the cylindrical part 80. Instead of wire cells 106, cells 106 with spherical portions, such as those illustrated in FIGS. 20A and 20B. The vision arrangement 102 of FIG. 21 can be reconfigured to the vision arrangement of FIG. 22, and conversely, by disassembling columns 111 of the vision arrangement 102 as needed, selectively adding or removing columns 111, and re-assembling the columns 111.

It should be appreciated that the various configurations shown in FIGS. 1-22 illustrate exemplary or different aspects of the machine vision inspection system 100 that can be used in any desired combination. Particularly, one configuration of the vision arrangement 102 can be converted to another by reconfiguring the corresponding vision structure 108 using the adjustable fastening devices 130. Reconfiguring can include any of the following: selectively adding or removing individual cells 106, individual vision elements 104, rows 109, and columns 111 of cells 106. Reconfiguring can also include adjusting the position of distance adjustability units 114, and/or the position of vision elements 104, by selective rotations and translations. Reconfiguring can also include selectively rotating entire rows 109 or columns 111 of the vision arrangement 102. Reconfiguring can also include selectively activating-deactivating individual vision elements 104 and/or rows 109 and/or columns 111 of the vision arrangement 102.

As an illustrative example, the vision arrangement 102 shown in FIG. 3 can be reconfigured to that of FIG. 5B. The vision arrangement 102 can be, for example, disassembled in separate rows 109. Adjacent rows 109 can be staggered relative to each other by ¼ cell length and re-assembled to each other. Additional new rows 109 can be assembled on the vision arrangement 102 following the same ¼ staggered pattern.

As another illustrative example, the vision arrangement 102 of FIG. 12B can be converted to the vision arrangement of FIG. 11 by, for example, disassembling individual cells 106 from each other, shifting the cells 106 relative to each other such that their centers define a curve that follows the surface 81 of the part, reassembling the cells 106 to each other, and moving the distance adjustability units 114 such that the distance adjustability units are completely retracted into their corresponding cells 106.

It will be appreciated from the above discussion that the machine vision inspection system 100 of the present teachings can provide inspection in the context of precision manufacturing processes using low-cost consumer sensors and light sources. Further, system redundancy provided by the plurality of vision elements 104 and system adjustability provided by the adjustable interconnections, allow quick and low-cost replacement of vision elements 104 without disassembling or shutting down the entire machine vision inspection system 100.

The machine vision inspection system 100 of the present teachings can avoid occlusion in dimension measurements of the part 80 by using multiple fields-of-views from individual sensor-type vision elements 104. Staggered-row configurations of the vision arrangement 102 reduce distortion by providing field-of-view overlaps, and distortion-free images of part edges.

The foregoing discussion discloses and describes merely exemplary arrangements of the present invention. One skilled in the art will readily recognize from such discussion, and from the accompanying drawings and claims, that various changes, modifications and variations can be made therein without departing from the spirit and scope of the invention as defined in the following claims.

What is claimed is:

1. A machine vision inspection system comprising:
a plurality of cells adjustably interconnected; and
a plurality of vision elements, each vision element adjustably supported within one of the cells;
wherein the cells and the vision elements can be selectively configured to define a vision arrangement capable of high-resolution inspection of a part.

2. The system of claim 1, wherein the vision arrangement can be reconfigured from a first configuration to a second configuration.

3. The system of claim 2, wherein one of the first and second configurations comprises rows of cells, each row staggered relative to an adjacent row by a row shift length, and the other of the first and second configurations comprises non-staggered rows of vision elements.

4. The system of claim 1, wherein the vision arrangement comprises rows of cells, and wherein at least one row is rotatable relative to another row.

5. The system of claim 1, wherein the vision arrangement is configured such that the vision elements define a curved surface that corresponds to a curved surface of the part.

6. The system of claim 5, wherein each vision element is positionable at a constant clearance distance from the curved surface of the part.

7. The system of claim 6, wherein each vision element is rotatable to an orientation perpendicular to the curved surface of the part.

8. The system of claim 1, wherein each vision element is coupled to a distance adjustability unit in a cell, the distance adjustability unit movable relative to the cell.

9. The system of claim 8, wherein each distance adjustability unit is movable for positioning each vision element at a constant clearance distance from a curved surface of the part.

10. The system of claim 1, wherein more than one vision element can be supported in any of the cells.

11. The system of claim 1, wherein the vision elements comprise mass-produced consumer sensors and light sources.

12. The system of claim 1, wherein the cells are adjustably supported on a fixture.

13. The system of claim 1, further comprising a control module operable for:
image acquisition;
inspection measurement;
system calibration; and
image construction/stitching.

14. The system of claim 13, wherein the control module is operable for selective activation/de-activation of each vision element.

15. The system of claim 13, further comprising a calibration rig, the calibration rig including color-coded information for automatic calibration of the vision arrangement.

16. The system of claim 1, wherein the vision arrangement moves relative to the part.

17. A method for reconfiguring the vision arrangement of claim 1, the method comprising:
selectively disassembling adjacent rows of cells from each other;
selectively shifting adjacent rows relative to each other; and
selectively re-assembling adjacent rows to each other.

18. The method of claim 17, further comprising adding and assembling new rows of vision elements.

19. A method for reconfiguring the vision arrangement of claim 1, the method comprising:
selectively disassembling adjacent cells from each other;
selectively disassembling adjacent rows of cells from each other;
selectively shifting each cell such that the centers of the vision elements are at constant clearance distance from a curved surface of the part;
selectively re-assembling adjacent cells to each other; and
selectively re-assembling adjacent rows to each other.

20. A method for reconfiguring the vision arrangement of claim 1, the method comprising:
selectively disassembling adjacent cells from each other;
selectively disassembling adjacent rows of cells from each other;
selectively shifting a distance adjustability unit of each cell such that the corresponding vision elements are at a constant clearance distance from a curved surface of the part;
selectively re-assembling the adjacent cells to each other; and
selectively re-assembling adjacent rows to each other.
